(19) United States
(12) Patent Application Publication
(10) Pub. No.: US 2012/0009427 A1
(43) Pub. Date: Jan. 12, 2012

(54) SOLVENT CAST FLAME RETARDANT POLYCARBONATE COATINGS, FILMS AND LAMINATES

(76) Inventors: Christopher Hable, Romeo, MI (US); Robert L. Gray, Hudson, OH (US); Henry C. Ashton, Aurora, OH (US)

(21) Appl. No.: 13/177,040

(22) Filed: Jul. 6, 2011

Related U.S. Application Data
(60) Provisional application No. 61/362,330, filed on Jul. 8, 2010.

(51) Int. Cl. B32B 27/08; C08L 27/06; C08K 5/1565; C08K 5/06; C08L 69/00; C08L 33/00

(52) U.S. Cl. 428/412; 524/537; 524/508; 524/108; 524/378

(57) ABSTRACT

Solvent cast polycarbonate-based films for use in laminates with flame retardance, low heat release and low smoke production, and methods of manufacture. Polycarbonate resin or polymer blends of polycarbonate resin and one or more polymer resins are solvent cast and incorporated into decorative, fire retardant and protective laminates.

### RELATED APPLICATIONS

This application claims priority to United States Provisional Patent Application Serial No. 61/362,330, filed on Jul. 8, 2010, which is incorporated herein by reference in its entirety.

### FIELD OF THE INVENTION

The present invention relates to solvent cast, flame retarded, polycarbonate-based coatings and films. Moreover, it relates to articles of manufacture incorporating the solvent cast films. Solvent cast films of the invention are particularly useful in design and manufacture of laminates for use in buildings and vehicles of mass transportation such as decorative laminates for rail and commercial aerospace applications.

### BACKGROUND OF THE INVENTION

Increased fuel economy is becoming increasingly important in all areas of transportation, driving the need for lighter weight designs with the associated difficulties in maintaining or even improving the strength and structural integrity of previous designs. Weight reduction is particularly important in vehicles for mass transportation such as trains and commercial airliners. To maintain, supplement and enhance the strength of light weight panels for flooring and sidewalls of commercial airliners, it is beneficial or even necessary that all components of the assembly contribute to the structural integrity of the final design. Thus, while decorative components used in the interior of an airliner cabin, such as decorative laminates, have typically performed exclusively or primarily an aesthetic role, it is increasingly important that they be designed to maintain, supplement or enhance the strength and durability of the panels and surfaces that they cover. The ability of the decorative laminate to increase strength and durability must be achieved while maintaining strict requirements for flame retardancy in the areas of heat release, smoke generation and emission of potentially harmful products on combustion.

The need for increased durability of decorative laminates with low weight, increased strength and excellent flame retardancy necessitates the use of new materials such as engineering thermoplastic resins not previously used in these applications. In addition, these materials must be available in thin coatings or films of 0.002 inches or less and sufficiently wide, e.g. 5 ft or more, to produce laminates for covering large panels. These are dimensions not easily achieved through conventional converting processes such as extrusion technology. Moreover, the extrusion of many engineering thermoplastics precludes the used of some useful flame retardants such as aluminum trihydrate (ATH) which decomposes at the high temperatures required for extrusion of many engineering thermoplastics.

A further deficiency in the production of thin polymeric films through extrusion is polymer chain orientation in the resulting film. This can create film properties with greater dependence on directionality. Orientation is frequently accompanied by residual stresses in the material that can lead to dimensional changes due to stress relaxation if the film material is reheated about its softening point in subsequent processing steps.

Polycarbonate materials are particularly problematic in that they are soluble in a limited number of solvents. Low molecular weight chlorinated solvents such as methylene chloride have been employed in dissolving polycarbonate resins. But methylene chloride is a suspect carcinogen and has the added problem of a low boiling point (41° C.). Tetrahydrofuran is also an effective solvent for polycarbonate resins but also has a low boiling point (65-67° C.), and produces solutions with poor stability at higher concentrations and is expensive.

1,3-dioxolane is know to be a suitable solvent for dissolution and casting of polycarbonate films. It is particularly preferred because of its higher boiling point of 76° C., similar to methyl ethyl ketone, a common solvent used in solvent casting operations. Optical quality films of neat polycarbonate polymers cast from solutions of 1,3-dioxolane with or without cosolvent are reported in U.S. Pat. No. 5,478,518 and U.S. Pat. No. 5,561,180. The prior art deals specifically with films for optical use and does not address the casting of formulated polycarbonate resin system for specific properties such as flame retardancy and strength.

### SUMMARY OF THE INVENTION

The present disclosure and related inventions overcome many difficulties and limitations in the extrusion of flame retarded engineering thermoplastic resin films, such as flame retarded polycarbonate based resins, by producing thin films cast from solvent. Solvent cast films or coatings of the present invention maintain the flame retardant characteristics and mechanical properties of the resin compound from which they were prepared and have comparable performance to extruded film of the same resin compound.

The present disclosure and related inventions provide thin, flame retarded, polycarbonate-based films produced through a solvent cast process. Moreover, it relates to articles of manufacture incorporating the solvent cast films. Solvent cast films of the invention are particularly useful in design and manufacture of laminates for use in the transportation industry such as decorative laminates for rail and commercial aerospace applications where strict regulatory requirements for flame retardant properties such as low smoke and heat release apply. Articles produced according to the invention have particularly good flame retardant properties such as low heat release and low smoke production.

While maintaining the flame retardant and mechanical properties of the resin compound, the solvent casting process offers several processing advantages. The lower temperatures required for dissolution of the resin and for solvent removal allow the use of flame retardant additives that are unstable to the high extrusion temperatures of most engineering thermoplastic resins. One commonly used flame retardant, alumina trihydrate, ATH, decomposes at 200° C., whereas extrusion temperatures of polycarbonate resins may exceed 230° C. or higher. The solvent cast process allows for incorporation of ATH into the film or coating to enhance the flame retardant properties of a particular resin.

The solvent casting process allows for the production of very thin coatings of 0.0005 inch or less because the resin dispersion can be cast directly onto a substrate or onto a carrier film or paper treated with an appropriate release coating. Coatings can be made at thickness that would normally be too thin for handling and would have a tendency to rip or tear. The coating cast on a release film or paper can then be transfer laminated to another substrate such as another polymeric sheet or film to form the final laminate structure.

Depending on the substrate to be coated, the solvent cast layer may be applied directly to a substrate to be coated. The only limitation of solvent casting process is that the substrate must be sufficiently resistant to the solvent being used to disperse the resin compound. For example the solvent cast process allows for coating and impregnation of porous substrates such as a paper or a woven or non-woven fabric or mat. Fiber materials suitable for use in fabrics or mats for coating and impregnation include but are not limited to glass, carbon, basalt and aramid including combinations of two or more materials. Impregnated materials may be consolidated under sufficient heat and pressure to form composite panels that may be used in construction applications or anti-ballistic panels.

An additional advantage of the solvent casting process is ease of pigmentation of the coating or film to achieve specific aesthetic appearance for use as a decorative color layer or surface layer. Even when the thin coating or film is used as a intermediate or backing layer in a multilayer laminate, it may be desirable to produce a film that matches the color of the surface layer, such that punctures, nicks, scratches that penetrate the surface layers of a laminate are less visible.

The current invention overcomes these difficulties and limitations of film extrusion by employing a solvent casting process to produce thin polycarbonate-based films from flame retardant resin compounds, maintaining in the film the good flame retardancy and mechanical properties of the original resin compound.

Another object of the present invention is to produce thin, flame retarded, polycarbonate-based film using a solvent cast process, while maintaining the unique flame retardant and physical properties of the base resin compound. A further object of the invention is to produce articles of incorporating these solvent cast, thin, flame retarded, polycarbonate-based films through lamination processes. Solvent cast films of the invention are particularly useful in design and manufacture of laminates for use in buildings and vehicles of mass transportation such as decorative laminates for rail and commercial aerospace applications.

### DETAILED DESCRIPTION OF THE INVENTION

Resins suitable for use in a solvent cast process include any of the grades of flame retarded resins grade of polycarbonate homopolymer, copolymer (for example polycarbonate/siloxane), terpolymer, polymer alloy or polymer blend and may be impact modified or unmodified. The grade is preferably selected to meet the flame retardant properties of the final application. Suitable grades are sold under the trade name Lexan (Sabic Innovative Plastics), Makrolon (Bayer) or Panlite (Teijin). The resin may also be a flame retarded polycarbonate/acrylonitrile butadiene stryrene (ABS) polymer alloy sold under the trade name Cycoloy (Sabic Innovative Plastics), Bayblend (Bayer) or Multiron (Teijin). A highly preferred grade for solvent cast films is a flame retarded polycarbonate terpolymer resin, Lexan FST9705, (Sabic Innovative Plastics).

The polycarbonate resin may be used alone in combination with one or more polymer resins to form a polymer blend to modify mechanical properties or achieve improved performance of the solvent cast film or coating in the target application. For example, a polymer blend may be selected to improve tensile strength or tensile elongation, increase impact strength, and improve flame retardancy of the cast film or to improve flame retardancy or formability in a decorative laminate containing the solvent cast film or coating. The polymer resin or resins must be soluble in the same solvent or solvent blend used to dissolve the polycarbonate based resin. Polymers suitable for use in a blend with the polycarbonate based resin include but are not limited to acrylic polymers or copolymers, thermoplastic polyurethanes and polyvinyl chloride polymers or copolymers. When a non-polycarbonate based polymer is incorporated in a blend it will typically be used at levels of less than 50%, preferable less than 40% and more preferably less than 30% of the combined weight of the polymer resins.

A preferred solvent for use in dissolving and dispersing the above resin compounds is 1,3-dioxolane, either alone or with a cosolvent. The cosolvent type and level is selected as to prevent premature skinning on the coating surface during the solvent removal process. The cosolvent must be miscible with the 1,3-dioxolane and does not cause precipitation or coagulation of the compound resin from the 1,3-dioxolane. To minimize skinning and improve coating quality, the cosolvent preferably has a higher boiling point than the 1,3-dioxolane solvent but cosolvents with too high of a boiling point will make complete solvent removal difficult. The cosolvent has a boiling point of preferable between 100 and 200° C., more preferably greater than 120 and 180° C. and even more preferably greater than 140 and 160° C.

Preferred cosolvents include but are not limited to toluene, PM acetate and glymes including but not limited to monoglyme diglyme and ethyl glyme. Certain solvents are to be avoided because of adverse affects on film properties such as increased brittleness. For example ketones, such as cyclohexanone are detrimental to film properties.

It should be noted that many of the above resins, as compounded resin products, consist of one or more polymeric materials or phases that will dissolve in the 1,3-dioxolane solvent or solvent blend but also contain particulate materials such as impact modifiers, mineral fillers and other additives that may not dissolve but exist in a dispersed phase after dissolution of the polymeric material. The flame retarded polycarbonate-based resin is dissolved in 1,3 dioxolane at a concentration of >20% resin solids, more preferably >25% resin solids and even more preferably >30% solids. The upper limit on solid content of the dispersion will be generally determined by the viscosity of the solvent dispersion which must be appropriate for the coating method employed. For example, a suitable viscosities for reverse roll coating is between 2500 to 15,000 cps and more preferably between 5000 and 10,000 cps. A solution of the Lexan FST9705 was produced at solids content of 27.5% in 1,3-dioxolane had a viscosity of 6600 cps, a viscosity suitable for reverse roll coating and many other coating methods.

Methods for coating a film of the polycarbonate resin dispersion may include but are not limited to gravure, reverse roll, knife over roll, air knife, wire wound metering rod (“Meyer Rod”), slot die, immersion (“dip”) or slot die (“extrusion”) coating. The coating method, and thus the compound viscosity of the dispersion will be selected for the application intended. For example, immersion coating will be used to coat a porous substrate, such as paper or glass, where some degree of penetration or impregnation is of the coating substrate is desired. Gravure coating may be preferred for generation of extremely thin films or coatings. For example, a suitable viscosities for reverse roll coating is between 2500 to 15,0000 cps and more preferably between 5000 and 10,000 cps. A solution of the Lexan FST9705 was produced at solids content of 27.5% in 1,3-dioxolane had a viscosity of 6600 cps, a viscosity suitable for reverse roll coating and many other coating methods.

The present invention also relates to articles incorporating the solvent cast thin films or coatings described above. Thin films or coatings according to the invention may be incorporated into articles where strength and flame retardancy are required. Applications include but are not limited to decorative laminates, non-textile flooring laminates and thermoplastic composites. Decorative laminates and non-textile flooring laminates constructed with films and coatings according to the invention are particularly suited for use on the interior surface of vehicles of mass transit such as commercial airliners and passenger train cars. Composite panels incorporating multiple layers of coated woven or non-woven fabrics or mats may be employed as structural members or anti-ballistic barriers in either stationary or mobile applications.

In decorative laminates, solvent cast polycarbonate based coatings or films may be employed as a backing layer, color layer or other internal layer in the construction. In its simplest embodiment the decorative laminate will consist of at least two layers including a clear surface layer; and a colored layer of solvent cast film according to the present invention. More typically the thin films according to the invention will be utilized as a backing layer or internal layer of the laminate that consist of three or more layers: (1) a surface layer; (2) a color layer; (3) a polycarbonate thin film layer according to the invention; (4) an optional backing layer composed of polyvinyl fluoride, polyvinylidene fluoride, polyvinyl chloride or an acrylic based polymer. Additional layers may be incorporated as needed, for example tie layers to enhance adhesion between the different layers of the laminate or print layers designed to enhance the aesthetic appearance of the laminate. The total thickness of tie layer and print layer constitute preferably less than 15%, more preferably less than 10% and even more preferably less than 5% of the total thickness of the laminate. Suitable laminate constructions for utilizing solvent cast, flame retarded, polycarbonate-based films, methods of manufacture and methods of use are described in the commonly assigned U.S. patent application Ser. No. 12/768,401, the entire disclosure of which is incorporated herein by reference.

In non-textile flooring laminates, a glass fabric with a solvent cast coating of a flame retarded polycarbonate-based resin is employed as a reinforcing layer on the bottom of or within the laminate. The non-textile flooring laminates are composed of one or more glass reinforcing layers and one or more polymeric surface layers. For example, an upper portion of the composite flooring system may be composed of a colored base layer beneath a clear cap layer. Additional layers in the composite flooring system include adhesive tie layers and optional decorative print layers. Suitable non-textile flooring laminate constructions for utilizing a reinforcing layer consisting of glass fabric with a solvent cast coating of a flame retarded polycarbonate-based resin are described in the commonly assigned U.S. patent application Ser. No. 12/716,502, the entire disclosure of which is incorporated herein by reference. In a preferred embodiment, the solvent cast coating may be applied to the glass fabric using an immersion or dip coating method to achieve some penetration of resin into the glass fabric. Alternatively, the glass fabric may be coated using other coating methods described above. However, these methods may necessitate that the glass fabric be coated on each side in two separate coating operations.

A fabric with a solvent cast coating of a flame retarded polycarbonate-based resin is also an intermediate in the construction of thermoplastic composite panels. Multiple plies of a coated fabric are stacked and placed between the platens of a heated press at sufficient temperature, pressure and time to consolidate the plies into a monolithic structure. Resin content of the resulting composite is controlled by the amount of resin coated onto the glass and the amount of heat, pressure and time applied in the consolidation step. The fiber composition, fabric weave style and resin content will be selected based on the intended application for the composite. For example, for anti-ballistic composites a woven roving fiberglass fabric with an S-glass or S2-glass composition with a resin content of about 20% or less is preferred. The anti-ballistic composite may be used alone for defeat of low velocity threats but more typically is employed as a spall liner behind a metallic or ceramic strike face to defeat high velocity threats and those with armor piercing capabilities. Fabrics composed of carbon fiber or basalt may also be suitable for anti-ballistic applications. For light weight applications the fiber of the composite may be of a polyaramid composition.

Where the composite is intended to provide only a structural function and where little or no benefit in weight reduction exists, a fabric material based on E-glass composition is preferred for economical reasons, even in cases where an overall thicker and heavier panel may be necessary.

The examples set forth below are illustrative of various embodiments of the principles and concepts of the disclosure and related inventions and do not otherwise limit the scope of the disclosure or claims.

### EXAMPLE 1

Approximately 182 g of Lexan FST9705 pigmented resin was dissolved in approximately 380 g of 1,3-dioxolane by slow mixing to produce a solution/dispersion of Lexan FST9705 of approximately 32.5% solids content. Lexan FST9705 resin was coated onto release paper between two parallel laboratory coating bars with a net gap of 0.005 inches. Solvent was removed at ambient conditions. The dried coating was removed from the release paper producing a free standing film with a nominal thickness of 0.002 inches. The film was used to construct a decorative laminate consisting of a 0.4 mil clear fluoropolymer surface layer, a 4 mil flame retarded vinyl embossing layer and the solvent cast Lexan FST 9705 film as a backing layer. The laminate was consolidated in a lab scale press at 310° F. and 150 psi for 5 minutes followed by a cooling cycle. The resulting decorative laminate material had an areal density of 254 g/m². The laminate produced a tensile strength of 201 N/25 mm of width. Flame resistance properties were measured according to FAR 25.853 Appendix F, Parts IV and V, with the laminates bonded to a standard crush core phenolic panel (available from Schneller, LLC) using a 2 mil layer of flame retardant heat activated adhesive. The material produced a 2 minute total heat release of 31.5 Kw.min/m² and a peak heat release rate of 32.0 Kw /m². Flaming smoke measurements produced a maximum smoke density within 4 min (Ds max) of 86.9.

### EXAMPLE 2

Lexan FST 9705 resin and a thermoplastic polyurethane resin, Estane 5713 (available from Lubrizol) were disperse in 1,3-dioxolane to a final solids content of approximately 28%. The ratio Lexan resin:Estane resin was approximately 4:1. The dispersion was coated onto release paper between two parallel laboratory coating bars with a net gap of 0.005 inches. Solvent was removed at ambient conditions and then at 95° C. for 10 minutes. The dried coating was removed from the release paper producing a free standing film with a nominal thickness of 0.002 inches. The film was used to construct a decorative laminate consisting of a 0.4 mil clear fluoropolymer surface layer, a 4 mil flame retarded vinyl embossing layer and the solvent cast Lexan FST 9705 film as a backing layer. The laminate was consolidated in a lab scale press at 310° F. and 150 psi for 5 minutes followed by a cooling cycle. Flame resistance properties of the laminate were measured according to FAR 25.853 Appendix F, Parts IV and V, with the laminates bonded to a standard crush core phenolic panel (available from Schneller, LLC) using a 2 mil layer of flame retardant heat activated adhesive. The material produced a 2 minute total heat release of 41.2 Kw.min/m² and a peak heat release rate of 44.4 Kw /m². Flaming smoke measurements produced a maximum smoke density within 4 min (Ds max) of 117.5.

### EXAMPLE 3

Lexan FST 9705 resin and an acrylic resin, Korad 6510AXP (available from Spartech) were disperse in 1,3-dioxolane to a final solids content of approximately 30%. The ratio Lexan resin:Korad resin was approximately 4:1. The dispersion was coated onto release paper between two parallel laboratory coating bars with a net gap of 0.005 inches. Solvent was removed at ambient conditions and then at 95° C. for 10 minutes. The dried coating was removed from the release paper producing a free standing film with a nominal thickness of 0.002 inches. The film was used to construct a decorative laminate consisting of a 0.4 mil clear fluoropolymer surface layer, a 4 mil flame retarded vinyl embossing layer and the solvent cast Lexan FST 9705 film as a backing layer. The laminate was consolidated in a lab scale press at 310° F. and 150 psi for 5 minutes followed by a cooling cycle. Flame resistance properties of the laminate were measured according to FAR 25.853 Appendix F, Parts IV and V, with the laminates bonded to a standard crush core phenolic panel (available from Schneller, LLC) using a 2 mil layer of flame retardant heat activated adhesive. The material produced a 2 minute total heat release of 42.6 Kw.min/m² and a peak heat release rate of 43.6 Kw /m².Flaming smoke measurements produced a maximum smoke density within 4 min (Ds max) of 96.1.

### Comparative Example: Extruded Lexan FST9705 Film

A film of extruded Lexan FST9705 resin nominally 2 mil thick was used to construct a decorative laminate consisting of a 0.4 mil clear fluoropolymer surface layer, a 4 mil flame retarded vinyl embossing layer and the solvent cast Lexan FST 9705 film as a backing layer. The laminate was consolidated in a production press at a peak temperature of 310° F. and 150 psi followed by a cooling cycle. The resulting laminate had an areal density of 245 g/m². The resulting laminates had an average tear strength of 1.65 N in the machine direct (direction of the continuous lamination) and 1.77 N in the cross machine direction when tested according to ISO 4674 method A2 at a test speed of 100 mm/min. The laminate produced a tensile strength of 196 N/25 mm of width in the machine direction and 203 N/25 mm in the cross machine direction when tested according to ISO 527-3 with a type 2 specimen at a test speed of 50 mm/min. Flame resistance properties were measured according to FAR 25.853 Appendix F, Parts IV and V, with the laminates bonded to a standard crush core phenolic panel (available from Schneller, LLC) using a 2 mil layer of flame retardant heat activated adhesive. The material produced a 2 minute total heat release of 35.7 Kw.min/m² and a peak heat release rate of 40.4 Kw /m². Flaming smoke measurements produced a maximum smoke density within 4 min (Ds max) of 98.1.

What is claimed is:

1. A solvent cast polycarbonate-based film comprising:
a polycarbonate resin;
a polymer resin; and
a solvent.

2. The solvent cast polycarbonate-based film of claim 1 in combination with a fluoropolymer surface layer and a vinyl embossing layer.

3. The solvent cast polycarbonate-based film of claim 2 as a backing layer to the fluoropolymer surface layer and vinyl embossing layer.

4. The solvent cast polycarbonate-based film of claim 1 wherein the polycarbonate resin is a homopolymer, copolymer, terpolymer, polymer allow or polymer blend.

5. The solvent cast polycarbonate-based film of claim 1 wherein the polycarbonate resin is a polymer blend of acrylic polymers or copolymers, thermoplastic polyurethanes or polyvinyl chloride polymers or copolymers.

6. The solvent cast polycarbonate-based film of claim 1 wherein the solvent is 1,3-dioxolane.

7. The solvent cast polycarbonate-based film of claim 1 wherein the solvent is a co-solvent.

8. The solvent cast polycarbonate-based film of claim 1 wherein the solvent is a co-solvent of PM acetate, monoglyme, diglyme, or ethyl glyme.

9. The solvent cast polycarbonate-based film of claim 1 wherein the polycarbonate resin is co-soluble with the polymer resin.

10. The solvent cast polycarbonate-based film of claim 1 wherein the polycarbonate resin is dissolved in 1,3 dioxolane at a concentration of greater than about 20% resin solids.

11. The solvent cast polycarbonate-based film of claim 1 wherein the polycarbonate resin is dissolved in 1,3 dioxolane with a final solids content of approximately 30%.
